(19) United States
(12) Patent Application Publication
(10) Pub. No.: US 2013/0304879 A1
(43) Pub. Date: Nov. 14, 2013

(54) CONFIGURATION OF AN END DEVICE FOR AN ACCESS TO A WIRELESS COMMUNICATION NETWORK

(71) Applicant: Vodafone Holding GmbH, Dusseldorf (DE)

(72) Inventor: Ulrich Schmidt, Dortmund (DE)

(21) Appl. No.: 13/863,627

(22) Filed: Apr. 16, 2013

(30) Foreign Application Priority Data
Apr. 16, 2012 (EP) 12002649.7

(51) Int. Cl. H04L 12/24

(52) U.S. Cl. CPC H04L 41/0803
USPC 709/220

(57) ABSTRACT

A method is provided to configure an end device (3) for an access to a first wireless communication network (9) formed by a network facility (4) with the participation of a configuration facility (5).

The end device (3) is connectable with the configuration facility (5) via a second communication network (1) and the network facility (4) is connectable with the configuration facility (5) via a third communication network (2).

Furthermore a configuration facility (5) and a network facility (4), is provided to at least partially perform one of the methods defined by the present invention.

The present invention relates to a method to configure an end device for an access to a first wireless communication network formed by a network facility.

Such configurations are particularly necessary, such that end devices, particularly mobile end devices like mobile phones, notebooks, tablet pc's or similar end devices, can access a secured radio network, particularly a secured WLAN (WLAN: Wireless Local Area Network), for example to be able to use internet content via the radio network.

Since a wireless communication network formed by a network facility, especially by a wireless access point (WAP), is usually secured by a password to avoid a misuse, it is necessary that the user, who wants to use the wireless communication network using an end device to for example access the internet, inputs corresponding configuration data into the end device and configures the end device for an access.

To fulfill present valid security demands a necessary password for an access to a wireless communication network formed by a network facility using a wide-spread authentification via PSK (PSK: Pre Shares Key) should comprise at least sixteen characters. Here on the one hand exists the problem of a correct input of the character string, such that a later authentification can succeed successfully, and on the other hand exists the problem that the public disclosure or propagation of the password is often undesired. Furthermore, often further information beside the password are necessary, to be able to authenticate at a network facility for an access to a communication network formed by the network facility, for example a network name, the kind of encryption and/or information regarding the MAC address (MAC: Media Access Control) of the end device which wants to access to the wireless communication network.

Against this background it is an object of the present invention to simplify the afore mentioned configuration, particularly in such a way that the input of a password by the user of an end device is not necessary.

To solve this problem the present invention suggests a method to configure an end device for an access to a first wireless communication network formed by a network facility with the participation of a configuration facility, wherein the end device is connectable with the configuration facility via a second communication network and the network facility is connectable with the configuration facility via a third communication network, comprising the following steps:
gathering an identifier assigned to the network facility and/or the first communication network with the end device, wherein the identifier is usable by the configuration facility for an identification of the network facility;
transmitting of the gathered identifier from the end device to the configuration facility via the second communication network;
use of the identifier received by the configuration facility to establish a communication link between the configuration facility and the network facility via the third communication network;
transmitting of data necessary for an access of the end device to the first communication network from the network facility to the configuration facility via the communication link between the configuration facility and the network facility;
use of the data received by the configuration facility to create configuration data by the configuration facility;
transmitting of the configuration data from the configuration facility to the end device via the second communication network;
and use of the configuration data to configure the end device.

The present invention is based on the realisation, that a configuration of an end device executed by a user for an access to a wireless communication network, preferably a secured WLAN, formed by a network facility, preferably a WLAN router, is not necessary when the end device to be configured is ready to operate in a further communication network, such that by means of the end device a communication link to a configuration facility can be established, wherein the configuration facility beside the communication link to the end device preferably can establish a further communication link, to the network facility, which forms the wireless network to which access is desired too, wherein the configuration facility can request necessary data from the network facility for an corresponding access to the wireless communication network with the end device and can transmit these data preferably together with further end device specific configuration data to the end device via the further communication network.

Preferably the method according to the invention is at least partially executed automatically, preferably initiated by the transmission of the gathered identifier from the end device to the configuration facility. Preferably the configuration data received by the end device therefore comprise executable commands, which cause the end device to automatically execute a configuration of the end device corresponding to the received configuration data.

According to a preferred embodiment of the method according to the invention it is required that the first communication network is formed according to a first standard in telecommunication and the second and/or third telecommunication network is formed according to a second standard in telecommunication. Particularly it is provided that the first telecommunication network is a secured radio network, preferably a secured WLAN, which corresponds to a WLAN standard according to a IEEE 802.11. A secured radio network or WLAN according to the invention is particularly a radio network which uses encryption and requires the input of a password for an access to the radio network. Furthermore, it is particularly provided that the second communication network is a mobile radio network, preferably a mobile radio network according to a GSM-, UMTS-, CDMA2000- and/or LTE-mobile radio standard. According to a further preferred embodiment the third communication network is a wired data network, advantageously a PSTN (PSTN: Public Switched Telephone Network). However, according to the invention it is particularly also provided that the second communication network and the third communication network are identical communication networks, preferably a mobile radio network according to a LTE mobile radio standard. A particularly preferred embodiment of the invention is characterized in that the network facility is a wireless access point, preferably a WLAN router. A further particularly preferred embodiment of the invention provides that the end device is a mobile end device, preferably a mobile phone or a tablet PC.

Independently from the design of the identifier gathered by the end device a user identifier is transmitted according to a preferred embodiment of the method according to the invention from the end device to the configuration facility via the second communication network. The user identifier is preferably used for an authentification of the end device and/or of the user of the end device by the configuration facility and/or by a further facility connected with the configuration facility or is usable for a corresponding authentification. Preferably the user identifier is the MSISDN (MSISDN: Mobile Subscriber Integrated Services Network Number) or the IMSI (IMSI: International Mobile Subscriber Identity) explicitly assigned to the user of a mobile end device. Preferably an identification of the network facility in the third communication network is enabled using the identifier and the user identifier. Preferably for this the identifier in connection with the user identifier is linked to a addressing information under which the network facility is addressable within the third communication network and is therefore accessable.

The authentification of the user identifier is preferably carried out by a comparison of the received user identifier with registered identifiers. The registered identifiers are preferably stored in a data base, which can be accessed by the configuration facility. By this authentification of the user the authorization of the user for an access to the first wireless communication network built by the network facility is preferably detectable or trackable without input of a codeword or password. The deposit of the user identifier in the data base can be done within a registration process, performed before particularly in case a mobile end device and the network facility are provided to the user from the same provider. Furthermore it is preferably provided that a corresponding registration is offered by the provider of the second communication network, wherein the provision of an access to a wireless network formed by a network facility, preferably an ecrypted WLAN, particularly for an access to the internet via the wireless communication network, is a special service proposal by the provider.

According to a further advantageous embodiment of the method according to the invention it is provided that within the configuration of the end device an access profile for an access to the first communication network by the use of the configuration data transmitted to the end device is created. Preferably this access profile is stored by the end device. In this way a particularly easy access to the first communication network formed by the network facility is enabled, wherein the user preferably must perform no input. Particularly the user must preferably not input a password or a network name for the access. In a further preferred embodiment of the method it is provided that the configuration data are transmitted to the end device as a configuration message, preferably using a OTA-SMS (OTA: Over The Air, SMS: Short Message Service). Preferably such configuration messages, like particularly OTA-SMS, are supported by a plurality of end devices, such that the method according to the invention can be used by a plurality of already available end devices.

According to a further preferred embodiment of the method according to the invention it is provided that the identifier transmitted from the end device to the configuration facility comprises a network name. According to a further preferred embodiment of the method it is required that the identifier transmitted from the end device to the configuration facility comprises a network facility device number.

Preferably an addressing information is allocatable by the configuration facility using the identifier, which allows an addressing of the network facility in the third communication network. By using the addressing information the network facility is preferably addressable for the provision of a communication link between the configuration facility and the network facility. Preferably the addressing information is linked to the identifier in a database, wherein the configuration facility has access to the database.

According to the invention the gathering of the identifier, which is useable by the configuration facility for a unique identification of the network facility, can be performed by an input of the user into the end device. The identifier can for example be a serial number provided on the network facility. Preferably it is provided, that the identifier of the network facility can be captured using the end device. In a preferred embodiment it is therefore a barcode provided on the network facility, which can be optically captured by the end device, preferably using a camera integrated into the end device. As a preferred alternative to this it is provided that the identifier is gathered wirelessly by the end device by using a RFID chip or NFC chip. According to a further embodiment of the invention it is provided that the identifier is the network name of the wireless communication network formed by the network facility, preferably the service set identifier (SSID). Preferably the network facility is designed to transmit at least the SSID in predetermined intervals to end devices located within the service area. WLAN router or wireless access points are therefore using so called beacons, which contain beside the SSID particularly the kind of encryption. Since the SSID is usually freely selectable and therefore not unique, it is according to the invention provided that for a unique identification of the network facility by the configuration facility not only the identifier is used, but also a further unique user identifier, preferably the MSISDN (MSISDN: Mobile Subscriber Integrated Services Digital Network Number) of the user and/or the IMEI (IMEI: International Mobile Station Equipment Identifier) of the end device. The usage of the identifier received by the configuration facility to a establish a communication link between the configuration facility and the network facility via the third communication network thereby particularly provides the usage of the received identifier together with a received unique user identifier, to determine an addressing information by means of previously deposited data sets, which preferably are maintained in a database, which allows to uniquely address the network facility within the third communication network, such that the configuration facility can establish a communication link to the network facility.

According to a further preferred aspect of the present invention the transmittal of the identifier from the end device to the configuration facility via the second communication network is achieved by a multimedia message. In a preferred embodiment it is required that the transmittal is achieved using a service of a mobile radio network, preferably via SMS or MMS (MMS: Multimedia Messaging Services). The usage of such standardized message formats particularly has the advantage that these can be billed by the provider of the second communication network to the user according to standardized determined conditions as a payable service.

According to a further preferred embodiment of the method according to the invention the transmittal of the identifier from the end device to the configuration facility via the second communication network and/or the transmittal of the configuration data from the configuration facility to the end device via the second communication network is achieved by a secured IP connection, wherein the transmittal preferably is achieved by using a dialogue between the end device and the configuration facility via a browser. Such a dialogue preferably offers the advantage that the user can be guided through the configuration and the execution of the inventive method is transparent for the user. Particularly the user can be referenced to terms of use, necessary inputs and/or corresponding costs as well as further information. Hereby, the acceptance of users regarding the utilization of the method according to the invention can be enhanced.

With the present invention furthermore a method for automatically configuring an end device for an access to a first communication network, particularly a wireless communication network, is proposed, wherein the configuration facility performs the following steps:
Set-up of a first link via a second communication network,
request of an identifier for the access of the end device to the second communication network via the first link,
receiving at least an identifier of the first communication network or an identifier of a network facility of the first communication network via the first link,
identifying a network facility by analyzing the received at least one identifier,
set-up of a second link with the identified network facility,
request of access data for an access of the end device to the first communication network of the network facility via the second link,
receiving of the access data for the access to the first communication network via the second link, wherein the access data comprise a first and a second access identifier for an access to the second communication network,
creation of a configuration message by using the received access data for an access to the first communication network,
send of the created configuration message via the first link.

Under an access to a communication network is particularly appreciated an admission to the communication network, as previously explained.

With the present invention furthermore a method for automatically configuring an end device for an access to a first communication network is propsed, wherein the end device performs the following steps:
Set-up of a first link to a second communication network,
transmittal of at least an identifier of a first communication network or an identifier of a network facility of the first communication network via the first link,
receiving a configuration message via the first link, wherein the configuration message comprises access data for an access to the first communication network,
creation of an access profile for an access to the first communication network by using the access data of the received configuration message, wherein the access data comprises a first and a second access identifier for an access to the first communication network,
request of access to the first communication network via the second link by transmitting the first and second access identifier of the created access profile to the network facility of the first communication network,
receiving of an allocated network address for an access to the first communication network from the network facility of the first communication network,
set-up of a second link via the first communication network by using the allocated network address.

An access to a communication network is particularly an admission to the communication network as previously explained.

A preferred advanced method for automatically configuring an end device for an access to a first communication network is designed such that the configuration facility performs the following additional steps after built up of the first link via the second communication network:
receiving a user identifier via the first link,
authentification of the user identifier by a comparison of the received user identifier with registered identifiers.

A further advancement of the method for automatically configuring an end device for an access to the first communication network is designed such that the end device performs the following additional steps after built up the first link via a second communication network:
transmittal of a user identifier via the first link.

Further preferred embodiments of the method are designed such that
the first communication network is designed according to a first telecommunication standard and the second communication network according to a second telecommunication standard;
the at least one identifier of the first communication network comprises a network name of the first communication network;
the identifier of the network facility of the first communication network comprises a network facility device number;
the transmittal of the at least one identifier of the first communication network or the identifier of the network facility of the first communication network is performed by transmitting the at least one identifier of the first communication network or the identifier of the network facility of the first communication network using a multimedia message;
and/or
the set-up of the first link in the second communication network is performed by a set-up of the first link as a secured IP-Link and by transmitting the at least one identifier of the first communication network or the identifier of the network facility of the first communication network by using of an input into a browser of the end device.

To solve the afore mentioned problem the present invention furthermore suggests a configuration facility for configuring an end device for an access to a first wireless communication network formed by a network facility, wherein the end device is connectable with the configuration facility via a second communication network and the network facility is connectable with the configuration facility via a third communication network, wherein the configuration facility is characterized by means to perform the method steps according to the invention, which are performed or are performable by the configuration facility.

Preferably the configuration facility comprises a configuration server, an authentification server, a database server, a configuration message server, a first interface to establish a first link with an end device via a second communication network and/or a second interface to establish a second link to the network facility of the first communication network. The link established via the second interface is preferably used for configuration. Preferably the configuration facility is a configuration server. Preferably the configuration server establishes the configuration according to the invention via a net based service and controls the configuration process.

A configuration facility according to the invention preferably comprises means for establishing a communication link via the second communication network and/or the third communication network, means for requesting identifiers for an access of an end device to the first communication network via the first link, means for receiving at least one identifier of the first communication network or an identifier of a network facility of the first communication network via the first link, means for identification of a network facility by analyzing the received at least one identifier, means for establishing a second link with the identified network facility, means for requesting access data for an access of the end device to the first communication network of the network facility via the second link, means for receiving the access data for an access to the first communication network via the second link, wherein the access data comprises a first and a second access identifier for an access to the first communication network, means for creating a configuration message by using the received access data for an access to the first communication network, means for sending the created configuration message via the first link, means for receiving a user identifier via the first link and/or means for authentication of the user identifier by a comparison of the received user identifier with registered identifiers.

To solve the afore mentioned problem the present invention furthermore suggests a network facility to form a wireless communication network, which is connectable to a configuration facility via a further communication network, which is characterized by means to perform the method steps according to the invention, which are performed or are performable by the network facility.

According to the invention it is preferably required that the network facility comprises a first interface to establish a first link with an end device via a first communication network and a second interface to establish a second link, wherein the second interface of the network facility is built and/or configured to send access data for an access of an end device to a first communication network, via the second link on a request of a configuration facility.

According to a preferred embodiment of the network facility according to the invention the network facility is a wireless access point or a WLAN router. Preferably the network facility comprises a control element as well as a display device, wherein by actuating the control element the display device displays an identifier, which is usable by a configuration facility according to the invention for an identification of the network facility.

With the present invention furthermore an end device, preferably a mobile end device, is suggested, which comprises means for performing the method steps according to the invention, which are performed or are performable by the end device. According to a preferred embodiment the end device comprises means to establish a first link via the second communication network, means to transmit at least one identifier of a first communication network or an identifier of a network facility of the first communication network via the link, means to receive a configuration message via the first link, wherein the configuration message comprises access data for an access of the end device to the first communication network, means to create an access profile for an access of the end device to the first communication network by using the access data of the received configuration message, wherein the access data comprises a first and a second access identifier for an access to the first communication network, means to request an access to the first communication network via the second link by linking the first and second access identifiers of the created access profile to a network facility of the second telecommunication network, means to receive an allocated network address for an access to the first communication network form the network facility of the first communication network, means to establish a second link via the first communication network by using the allocated network address and/or means to transmit a user identifier via the first link.

In the following two configuration scenarios are described, wherein the first communication network is an encrypted WLAN, the second communication network is a mobile radio network, the end device is a mobile end device usable in a mobile radio network, the network facility is a WLAN router and the configuration facility is a configuration server. Preferably the configuration of a secured WLAN access or WLAN admission via a WLAN router can be performed by using a mobile end device via a net based service without the utilization of a PC. The configuration server preferably controls the configuration process in essence. The WLAN router is preferably designed to support a net based configuration and to transmit a device ID when the method according to the invention is executed, according to which the WLAN router preferably comprises a special firm ware. Using the device ID it is preferably possible to uniquely identify the WLAN router as a device in a communication network. According to a first embodiment the device ID can be a serial number of the device or a likewise permanently implemented manner be displayed at the outer surface of the device to the user. According to a second embodiment the ID is a key randomly created by the WLAN router, wherein the key is either transmittable via the WLAN router to the mobile end device or can be displayed using a display device of the WLAN router, preferably after actuating a control element of the WLAN router.

In case the device ID is a serial number or a permanently implemented ID it is provided that the user initiates a communication with the configuration server using the mobile end device, which after establishing a communication link sends the mobile end device data, which are displayed at a browser of the mobile end device. These data guides the user using a dialogue through the configuration. Initially the customer must thereby enter the device ID of the WLAN router into a dialogue field. Alternatively to this it is required that a picture of a barcode located at the casing of the WLAN router is taken using the end device or a camera integrated into the end device and this is transmitted to the configuration server using the end device. Once the user has transmitted a valid device ID to the configuration server by the mobile end device the actual configuration process is started. The configuration server determines an addressing information linked to the device ID by using a data base and thus uses the device ID for the establishment of the communication link with the WLAN router. If the communication link is established the configuration server requests from the WLAN router the access data necessary for an access to the WLAN formed by the WLAN router. After that the access data are transmitted to the configuration server, which sends the configuration data comprising the access data to the mobile end device. Therefore the configuration server uses a OTA-SMS.

In case the device ID is a randomly generated device ID it is preferably required that the configuration is initiated by the WLAN router. If a randomly device ID is generated such that this is detectable by the mobile end device the WLAN router establishes a link to the configuration server and transmits the randomly generated device ID to the configuration server. To identify the WLAN router or to assign the WLAN router to the mobile end device for using an access to the communication network formed by the WLAN router it is provided that the user establishes a communication link to the configuration server using the mobile end device and transmits the device ID. Additionally to the device ID the MSISDN and/or the IMSI of the user are transmitted to the configuration server.

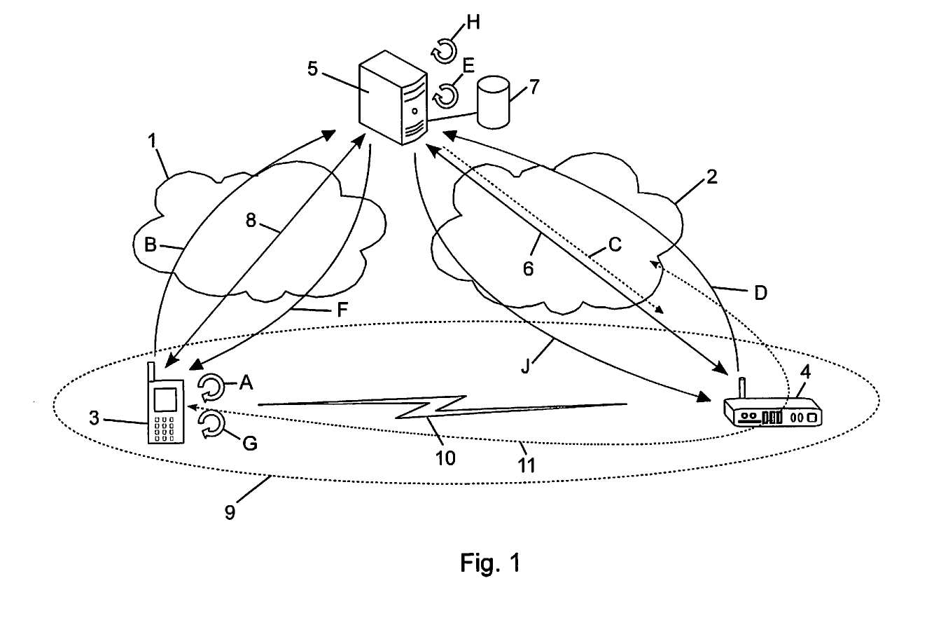

Further preferred details, features and embodiments of the present invention are explained with respect to the embodiment shown in FIG. 1. Thereby shows

FIG. 1 in a schematic view an embodiment of a method according to the invention.

In FIG. 1 an embodiment of a method according to the invention for configuring an end device 3 for an access to a first wireless communication network 9 formed by a network facility 4 with the participation of a configuration facility 5 is shown, wherein the end device 3 is connectable with the configuration facility 5 via a second communication network 1 and the network facility 4 is connectable with the configuration facility 5 via a third communication network 2. The shown method comprises the following steps:
gathering A an identifier assigned to the network facility 4 and or to the first communication network 9 with the end device 3, wherein the identifier is usable by the configuration facility 5 for an identification of the network facility 4;
transmitting B of the gathered identifier from the end device 3 to the configuration facility 5 via the second communication network 1;
use of the identifier received by the configuration facility 5 to establish C a communication link 6 between the configuration facility 5 and the network facility 4 via the third communication network 2;
transmitting D of data necessary for an access of the end device 3 to the first communication network 9 from the network facility 4 to the configuration facility 5 via the communication link 6 between the configuration facility 5 and the network facility 4;
use of the data received by the configuration facility 5 to create E configuration data by the configuration facility 5;
transmitting F of the configuration data from the configuration facility 5 to the end device 3 via the second communication network 1;
and
use of the configuration data to configure G the end device 3.

The method according to the invention is explained in the following in more detail. According to the shown embodiment the first communication network 9 is a secured or encrypted WLAN (symbolically depicted by the dashed ellipse) and the second communication network 1 is a mobile radio network (symbolically depicted as a cloud). The third communication network 2 is a wired data net (symbolically depicted as cloud). The end device 3 is a mobile phone, which is operable in the mobile radio network 1. The mobile phone 1 is furthermore designed to communicate via a radio interface with the network facility 4, presently a WLAN router, presently symbolically depicted by zigzag arrow 10. The data transmission within the radio network formed by the WLAN router 4 is preferably done according to an IEEE-standard, preferably according IEEE 802.11n. The configuration facility 5 is presently a configuration server, which has access to a data base 7. In data base 7 identifiers are stored, which allow a unique identification of network facilities in the third communication network 2, particularly by linking with corresponding addressing information. Particularly an identifier for a unique identification of the WLAN router 4 is stored in data base 7, wherein the identifier allows an addressing of the network facility 4 in the third communication network 2 by corresponding linking. In so far the identifier is useable to establish a communication link 6 between the configuration facility 5 and the network facility 4 via the third communication network 2. Furthermore at least one user identifier is stored in the data base 7, presently the MSISDN of the user, wherein the user identifier is linked to data regarding the user. Further it is required with respect to the shown method that in data base 7 the IMEI of the mobile end device 3 is stored. With the IMEI preferably individual end device configuration data is linked.

Wirth the method shown in FIG. 1 it is provided that initially an identifier of the WLAN router 4 is gathered with the mobile phone 3. The identifier is presently the serial number of the WLAN router, which is linked in the data base 7 with a corresponding addressing information, whereby an identification of the WLAN router 4 in the third communication network 2 is possible. For gathering the serial number it is provided that the user of the mobile phone 3 reads the serial number of the WLAN router 4 and enter this into the mobile phone by means of an input devices of the mobile phone 3. In a more comfortable presently not shown embodiment it is provided that the gathering of the serial number by means of the mobile phone 3 is done by taking a picture of the serial number by means of a camera provided by the mobile phone 3.

The gathering of the serial number as an identifier by the mobile phone 3 is presently symbolically shown by the arrow with the reference A.

After gathering the identifier a communication link 8 (symbolically shown by the double arrow) via the mobile radio network 1 to the configuration server 5 is established by the mobile phone 3. By using the communication link 8 the mobile phone 3 transmits the gathered serial number of the network facility 4 together with the MSISDN of the user as well as the IMEI of the mobile phone 3 to the configuration server 5. The transmission is presently symbolically shown by arrow B. After the configuration server 5 has received the data from the mobile phone 3 an authentification of the user identifier, presently of the MSISDN, takes place by the configuration server 5, wherein the authentification of the user identifier is done by a comparison of the received MSISDN with corresponding user identifiers stored in the data base 7. The authentification is presently symbolically shown by arrow H. By using the authentification it is preferably detectable by the configuration facility 5 whether the user is authorized to access the WLAN 9.

After a successful authentification the communication server 5 establishes a communication link 6 (symbolically shown by double arrow) between the configuration server 5 and the WLAN router 4 via the third communication network 2, wherein the configuration server 5 uses the serial number transmitted to the configuration server 5 to establish the communication link 6 whereby the configuration server 5 identifies the addressing information linked to the serial number in the data base 7. The establishment of the communication link 6 is in FIG. 1 symbolically shown by dashed arrow C. Via the communication link 6 the configuration server 5 requests from the WLAN router 4 data for an access to the WLAN 9, particularly the network name and the necessary password, presently symbolically shown by arrow J. Thereupon the WLAN router 4 transmits in a method step symbolically shown by arrow D the requested data to the configuration server 5. The configuration server 5 creates thereupon configuration data for the configuration of the mobile phone 3 for an access to the WLAN 9 by using data provided by the WLAN router 4 and by using of end device specific configuration data linked to the IMEI in the data base 7. The creation of these configuration data by the configuration server 5 is presently symbolically shown by arrow E.

After creation of the configuration data the configuration server 5 sends the created configuration data as a configuration message to the mobile phone 3. The transmission of the configuration data is symbolically shown by arrow F. For the transmission of the configuration data the configuration server 5 uses the at the beginning of the method by the mobile phone 3 established communication link 8 via the mobile radio network 1. With the reception of the configuration data by mobile phone 3 the mobile phone 3 is automatically configured for an access to the WLAN 9, wherein particularly the access data necessary for an access are stored by the mobile phone 3, particularly the network name and the password of the encrypted WLAN 9. According to a preferred embodiment of the method a necessary password for an access to the first wireless communication network 9 remains invisible to the user, such that a not authorized propagation of the password is not possible by the user.

The communication link 8 established between the mobile phone 3 and the configuration server 5 via the mobile radio network 1 is presently used by a browser of the mobile phone 3, wherein information regarding the process of the method are displayed to the user in a dialogue displayed by the browser.

After a successful configuration of the mobile phone 3 for an access to the radio network 9 the mobile phone 3 can preferably establish a communication link 11 (symbolically shown by dashed double arrow) to a third communication network 2 via the WLAN router 4, if the mobile phone is located within the local radio network 9 (symbolically shown by dashed ellipse).

According to a preferred apply of the method according to the invention the user of the end device 3 is also time owner of the WLAN router 4 or of a wireless access point. The user thereby uses the method for an integration of his WLAN-capable end device 3 into an existing secured WLAN, wherein preferably the input of a password as well as a configuration via a PC is not necessary. The end device 3 communicates therefore via a mobile radio network 1 with the configuration server 5, to conduct the integration of the end device 3 which has to be integrated user friendly. At this the method according to the invention is used. The configuration server 5 is thereby informed of the router ID by the end device 3 via the communication channel 8, whereby the further method steps of the configuration process according to the invention are started.

The embodiment shown in FIG. 1 only serves as an illustration of the invention and is not limiting for this.

### REFERENCE LIST

1 second communication network (mobile radio network)

2 third communication network (wired data network)

3 end device (mobile phone)

4 network facility (WLAN router)

5 configuration facility (configuration server)

6 communication link (between configuration facility (5) and network facility (4))

7 data base

8 communication link (between end device (3) and configuration facility (5))

9 first communication network (WLAN)

10 radio link between end device (3) and network facility (4)

11 access to the third communication network (2) by the end device (3) via the first communication network (9) formed by the network facility (4)

A gathering an identifier

B transmitting of the detected identifier

C establishing of a communication link (6)

D transmitting of data

E creation of configuration data

F transmitting of the configuration data

G configuration of the end device (3)

H authentification of the user

J request for data

1. Method to configure an end device for an access to a first wireless communication network formed by network facility with the participation of a configuration facility,
wherein the end device is connectable with the configuration facility via a second communication network and
the network facility is connectable with the configuration facility via a third communication network,
comprising the following steps:
gathering an identifier assigned to the network facility and/or to the first communication network with the end device, wherein the identifier is usable by the configuration facility for identification of the network facility;
transmitting of the gathered identifier from the end device to the configuration facility via the second communication network;
use of the identifier received by the configuration facility to establish a communication link between the configuration facility and the network facility via the third communication network;
transmitting of data necessary for an access of the end device to the first communication network from the network facility to the configuration facility via the communication link between the configuration facility and the network facility;
use of the data received by the configuration facility to create configuration data by the configuration facility;
transmitting of the configuration data from the configuration facility to the end device via the second communication network; and
use of the configuration data to configure the end device.

2. Method according to claim 1, characterized in that the first communication network is formed according to a first standard in telecommunication and the second and/or third telecommunication network is formed according to a second standard in telecommunication.

3. Method according to claim 1, characterized in that the network facility is a wireless access point, preferably a WLAN router.

4. Method according to claim 1, characterized in that the end device is a mobile end device, preferably a mobile phone.

5. Method according to claim 1, characterized in that a user identifier is transmitted from the end device to the configuration facility via the second communication network, which is preferably usable for an authentification of the end device and/or of the user of the end device by the configuration facility and/or by a further facility connected with the configuration facility.

6. Method according to claim 5, characterized in that an identification of the network facility in the third communication network is enabled using the identifier and user identifier.

7. Method according to claim 5, characterized by an authentification of the user identifier by a comparison of the received user identifier with registered identifiers.

8. Method according to claim 1 characterized in that within the configuration of the end device an access profile for an access to the first communication network by the use of the configuration data transmitted to the end device is created.

9. Method according to claim 1, characterized in that the configuration data are transmitted to the end device as a configuration message.

10. Method according to claim 1, characterized in that the identifier transmitted from the end device to the configuration facility comprises a network name.

11. Method according to claim 1, characterized in that the identifier transmitted from the end device to the configuration facility comprises a network facility device number.

12. Method according to claim 1, characterized in that the transmittal of the identifier from the end device to the configuration facility via the second communication network is achieved by a multimedia message.

13. Method according to claim 1, characterized in that the transmittal of the identifier from the end device to the configuration facility via the second telecommunication network and/or the transmittal of the configuration data from the configuration facility to the end device via the second communication network is achieved by a secured IP connection, wherein the transmittal preferably is achieved by using a dialogue between the end device and the configuration facility via by a browser.

14. Configuration facility for configuring an end device for an access to a first wireless communication network formed by a network facility wherein the end device is connectable with the configuration facility via a second communication network and the network facility is connectable with the configuration facility via a third communication network, characterized by means to perform the method steps according to claim 1, which are performed by the configuration facility.

15. Network facility to form a wireless communication network which is connectable to a configuration facility via a further communication network, characterized by means to perform the method steps according to claim 1, which are performed by the network facility.
